(19) United States
(12) Patent Application Publication
(10) Pub. No.: US 2026/0084830 A1
(43) Pub. Date: Mar. 26, 2026

(54) ANGLE-OF-ATTACK (AOA) INTEGRITY MONITORING

(71) Applicant: BETA AIR LLC, South Burlington, VT (US)

(72) Inventor: Collin Freiheit, Burlington, VT (US)

(21) Appl. No.: 19/334,583

(22) Filed: Sep. 19, 2025

Related U.S. Application Data
(60) Provisional application No. 63/697,247, filed on Sep. 20, 2024.

(51) Int. Cl. B64D 43/02; B64C 29/00

(52) U.S. Cl. CPC B64D 43/02; B64C 29/0025

(57) ABSTRACT

An electrically powered aircraft is configured estimate a true angle-of-attack (AoA) for an aircraft. A controller may receive one or more measurements associated with an aircraft, such as vane angle values, inertial measurement unit (IMU) data, and airspeed data. Discrepancies between vane angle values measured by different AoA sensors and an aircraft's true AoA may include fuselage effects, such as flow interference around the nose at different combinations of true AoA and angle-of-sideslip (AoS) causing different local AoA at the different vanes. The controller may generate and utilize a side slip estimate to determine if the difference in vane angle values is due to side slip or a malfunctioning AoA sensor. In some cases, if the difference in the vane angle values is determined to be due to a malfunctioning AoA sensor, then the controller may perform one or more actions (e.g., deactivate a stall barrier protection)

### RELATED APPLICATIONS

This application claims priority to U.S. Provisional Patent Application No. 63/697,247, filed Sep. 20, 2024, titled “ANGLE-OF-ATTACK (AOA) INTEGRITY MONITORING,” the entirety of which is incorporated herein by reference.

### BACKGROUND

In electrically propelled vehicles, such as an electric vertical takeoff and landing (eVTOL) aircraft, it is essential to maintain the integrity and safe operation of the components of the aircraft until safe landing. If one or more components, such as an AoA sensor, malfunctions or stops operating, the safety of the eVTOL, along with those onboard, may be compromised. In some cases, stall barrier protection (e.g., dynamic pitch command saturation angle of attack limiter) requires an AoA reading. If the eVTOL has only two AoA sensors and the readings do not agree, the flight controller will not have a basis for determining which sensor reading is correct. The disclosure herein addresses this and other flight safety issues.

### SUMMARY

In an aspect of the present disclosure, an AoA controller includes one or more processors and one or more computer-readable media storing computer-executable instructions that, when executed by the one or more processors, cause the one or more processors to receive first vane angle data from a first vane, receive second vane angle data from a second vane, and receive airspeed data from an airspeed sensor. The one or more processors further generate a side slip estimate based at least in part on the inertial data and the airspeed data. The one or more processors still further determine a first estimated AoA associated with the first vane based at least in part on the side slip estimate and determine a second estimated AoA associated with the second vane based at least in part on the side slip estimate. The one or more processors still further determine a difference between the first estimated AoA and the second estimated AoA and perform an action in response to the delta being above a threshold value.

In another aspect of the present disclosure, a method includes receiving first vane angle data from a first vane, receive second vane angle data from a second vane, and receive airspeed data from an airspeed sensor. The method further includes generating a side slip estimate based at least in part on the inertial data and the airspeed data. The method further includes determining a first estimated AoA associated with the first vane based at least in part on the side slip estimate and determine a second estimated AoA associated with the second vane based at least in part on the side slip estimate. The method further includes determining a difference between the first estimated AoA and the second estimated AoA and perform an action in response to the delta being above a threshold value.

In yet another aspect of the present disclosure, an aircraft includes a flight controller, an AoA controller configured to provide commutation signals to the flight controller, and one or more AoA sensors communicatively coupled to the AoA controller. The AoA controller is configured to generate a side slip estimate based at least in part on the inertial data and the airspeed data. The AoA controller is further configured to determine a first estimated AoA associated with the first vane based at least in part on the side slip estimate. The AoA controller is still further configured to determine a second estimated AoA associated with the second vane based at least in part on the side slip estimate and determine a difference between the first estimated AoA and the second estimated AoA.

### BRIEF DESCRIPTION OF DRAWINGS

FIG. 1A is a block diagram of an example electric vertical takeoff and landing (eVTOL) aircraft, according to examples of the disclosure.

FIG. 1B is another block diagram of an example eVTOL aircraft, according to examples of the disclosure.

FIG. 2 is a schematic illustration of an example architecture of a controller area network (CAN) bus system of an aircraft, according to examples of the disclosure.

FIG. 3 is a flow diagram depicting an example architecture illustrating a flow of data for generating estimated AoAs for an aircraft, according to examples of the disclosure.

FIG. 4 is a block diagram depicting an example method for ensuring the integrity of AoA data monitored by aircraft, according to examples of the disclosure.

FIG. 5 is a block diagram depicting another example method for ensuring the integrity of AoA data monitored by aircraft, according to examples of the disclosure.

FIG. 6 is a block diagram of a controller of an aircraft, according to examples of the disclosure.

### DETAILED DESCRIPTION

Wherever possible, the same reference numbers will be used throughout the drawings to refer to the same or like parts.

The disclosure herein is directed to systems, methods, and apparatus for estimating a true AoA for an aircraft. In examples of the disclosure, the aircraft may include an electric vertical takeoff and landing (eVTOL) aircraft and/or in a conventional takeoff and landing (CTOL) aircraft. Although disclosed in the context of an eVTOL aircraft, it should be understood that the disclosure herein may be applied to any situation in which it is desired to determine an accurate angle at which a chord of an aircraft's wing meets the relative wind. For example, if two different AoA values are detected and the delta between the AoA values is greater than a threshold value, the disclosure herein allows for a determination to be made as to if the difference in the AoA readings is due to side slip or a malfunctioning AoA sensor, if the latter, deactivate stall barrier protection (e.g., dynamic pitch command saturation angle of attack limiter).

AoA sensors may be used for stall barrier protection. In some cases, values obtained from the AoA sensors can differ from one another due to side slip of the aircraft. According to this disclosure, a side slip estimate may be generated to determine if the difference in AoA values is due to side slip or malfunctioning AoA sensor. In some cases, if the difference in the AoA values is determined to be due to a malfunctioning AoA sensor, then the controller may deactivate stall barrier protection. In some examples, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically).

In some cases, reasons for discrepancies between vane angle values measured by different AoA sensors and an aircraft's true AoA may include fuselage effects, such as flow interference around the nose at different combinations of true AoA and angle-of-sideslip (AoS) causing different local AoA at the different vanes. Other factors that may cause these discrepancies include kinematic effects, such as roll, pitch, and yaw body rates (p,q,r), causing local linear velocities at the vanes, relative to a center of gravity of the aircraft, because they are not mounted at the center of gravity of the aircraft. The local velocities at the vanes may affect the relative wind at the vane locations, and therefore the local AoA as measured by the vanes.

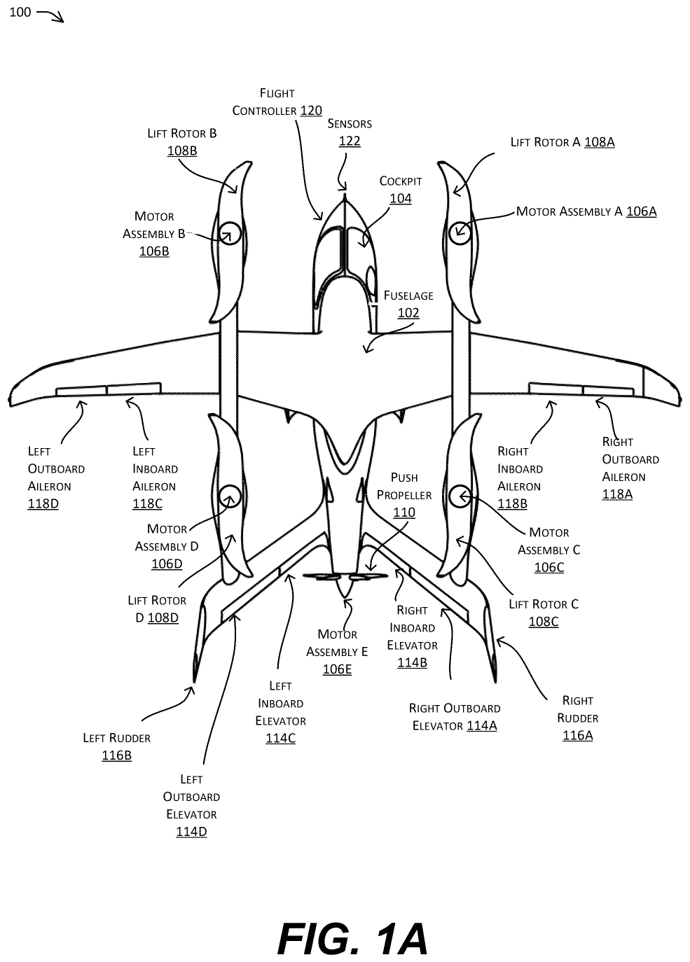

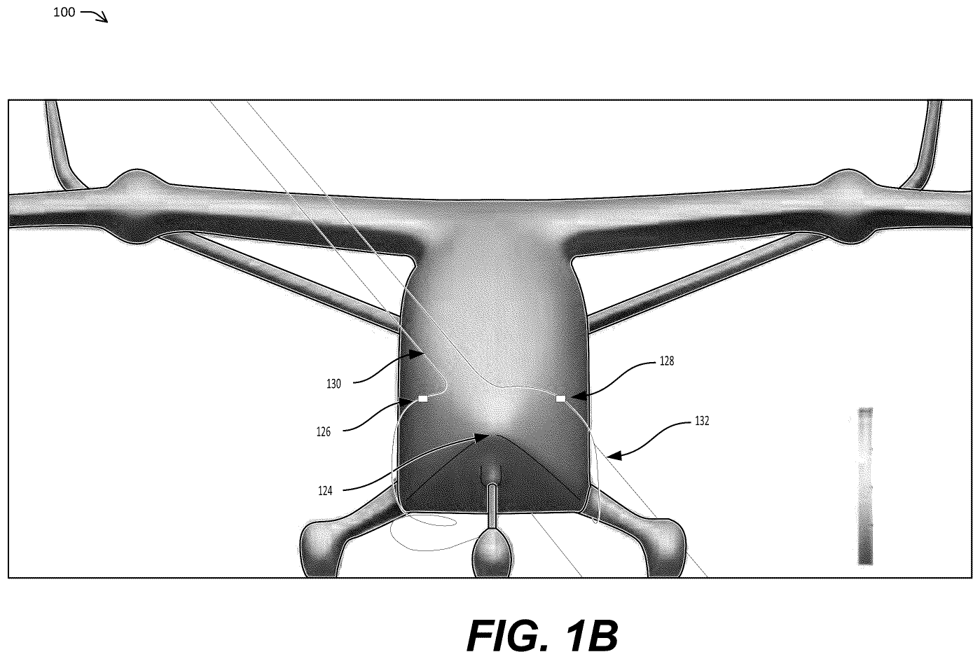

FIG. 1A is a block diagram of an example electric vertical takeoff and landing (eVTOL) aircraft 100, according to examples of the disclosure. The aircraft 100 includes a fuselage 102 and a cockpit 104 to carry passengers and/or a pilot. In alternate cases, the aircraft 100 may be unmanned and controlled remotely. In some cases, the aircraft 100 may have a fly-by-wire control system.

Although, discussed in the context of an eVTOL aircraft 100, it should be understood that the disclosure herein may be applied to any use case where an accurate AoA and verification that AoA sensors are operating with integrity is desired. Thus, the disclosure may be applied to any variety of transportation applications, such as electric watercrafts, electric cars, electric heavy machinery, electric trucks, electric trains, electric busses, or the like.

The aircraft 100 may include motor assembly A 106A, motor assembly B 106B, motor assembly C 106C, motor assembly D 106D, and motor assembly E 106E, hereinafter referred to in the singular as motor assembly 106 or in the plural as motor assemblies 106. The motor assemblies 106 may be positioned to balance thrust and/or lift distribution across the aircraft 100. In some embodiments, one or more of the motor assemblies 106 may be configured for redundancy or for failover purposes. For example, in some cases, if motor assembly A 106A were to fail and/or operate at a reduced capacity, a set of other motor assemblies (e.g., motor assembly B 106B, motor assembly C 106C, and/or motor assembly D 106D) may be configured to compensate for the reduced and/or lost operational capacity of motor assembly A 106A.

The motor assemblies 106 may be configured to drive (e.g., rotate) one or more propulsors, such as lift rotors 108A, 108B, 108C, 108D, hereinafter referred to in the singular as lift rotor 108 or in the plural as lift rotors 108, and/or a push propeller 110. For example, motor assembly A 106A may be configured to drive the lift rotor A 108A, motor assembly B 106B may be configured to drive the lift rotor B 108B, motor assembly C 106C may be configured to drive the lift rotor C 108C, motor assembly D 106D may be configured to drive the lift rotor D 108D, and motor assembly E 106E may be configured to drive the push propeller 110. In some examples, lift rotors 108 may be configured to enable the vertical takeoff of the aircraft 100, while the push propeller 110 may be configured to enable the horizontal movement of the aircraft.

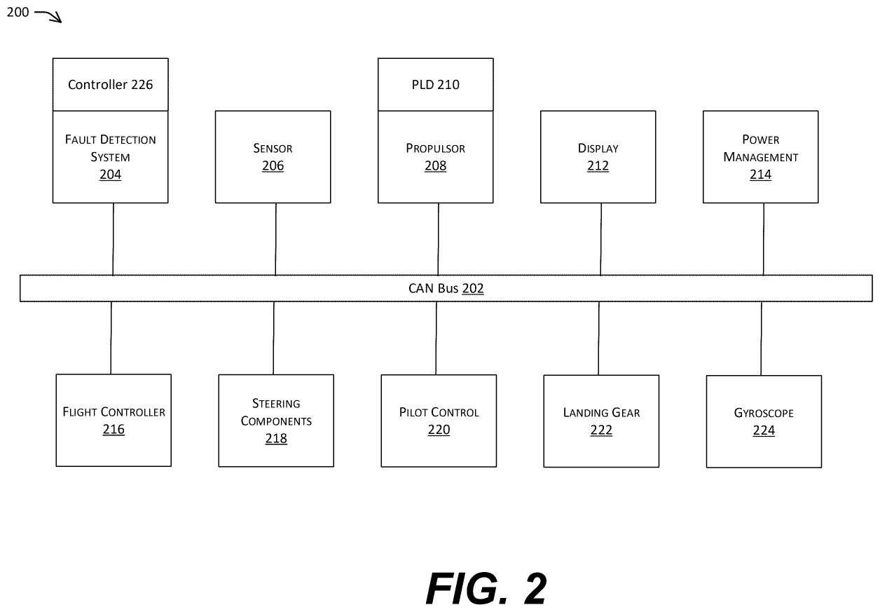

The motor assemblies 106 may include an electric motor and associated hardware and software to control the operation of the motor assemblies 106, as will be discussed in conjunction with FIG. 2. The aircraft 100 may include one or more energy sources such as one or more batteries (not shown) to store electric energy that is used to energize the motor assemblies 106 to drive their corresponding lift rotors 108 and/or push propeller(s) 110. For example, a battery may store electrical energy and provide that energy, as controlled by the components of the motor assembly 106 to provide direct current (DC) electric power to power motors of the motor assemblies 106 to rotate the corresponding lift rotors 108 and/or push propeller 110. The motor assemblies 106 may operate at any suitable voltage, current, and/or power. For example, the motor assemblies may operate in a voltage range of about 25 volts to about 500 volts and a current range of about 10 Amps to about 100 Amps. In some cases, the operating voltage range of about 50 volts to about 300 volts and a current range of about 20 Amps to about 40 Amps. An inverter, as discussed further in conjunction with FIG. 2, may convert the DC electric power stored by a battery into alternating current (AC) power and/or pulse width modulated (PWM) power and provide the AC and/or PWM power to the motors in each of the motor assemblies 106 as commutation signals.

The aircraft 100 includes a set of control surfaces, such as a right outboard elevator 114A, right inboard elevator 114B, left inboard elevator 114C, and left out board elevator 114D, hereinafter referred to in the singular as elevator 114 or in the plural as elevators 114. The elevators 114 are configured to control the pitch of the aircraft 100. In some cases, the elevators 114 on both sides of the aircraft 100 may be partitioned into two or more components to provide more precise control over the pitch of the aircraft 100 and/or to provide redundancy in the event of any component failure. For example, in some embodiments, having two or more elevators 114 on each side enables independently controlling those elevators 114 to enable more fine-tuned control over the pitch of the aircraft 100. Additionally, in the event of failure of a first elevator 114 on one side, a second elevator 114 on the same side may enable control of the pitch of the aircraft 100 on that side to mitigate the effects of the failure.

Additional control surfaces of the aircraft 100 include a right rudder 116A and left rudder 116B, hereinafter referred to in the singular as rudder 116 or in the plural as rudders 116, to control yaw of the aircraft 100. Although, unlike the elevators 114, the rudders 116 of the aircraft 100 are not depicted as partitioned on two sides it should be understood that in some airframe embodiments, the rudders 116 of the aircraft 100 may be partitioned on one or both sides. Still further, the aircraft 100 may include a right outboard aileron 118A, a right inboard aileron 118B, a left inboard aileron 118C, and a left outboard aileron 118D, hereinafter referred to in the singular as aileron 118 or in the plural as ailerons 118, to generate lift or drag. Any of the control surfaces 114, 116, 118 may be of more or less numbers and may be controlled by a pilot, a remote operator, or a bot, either directly or indirectly (e.g., fly-by-wire). Each of the control surfaces 114, 116, 118 may be controlled using one or more actuators (not shown).

As further depicted in FIG. 1A, the aircraft 100 includes a flight controller 120. The flight controller 120 may include one or more flight controller components (e.g., one or more flight control computers (FCCs)) configured to generate command signal(s) that control the operation of various components of the aircraft 100. For example, the flight controller unit 120 may be configured to generate command signal(s) that control the operation of one or more inverters that provides electrical power and/or commutation within the motor assemblies 106 of the aircraft 100, an actuator that controls the operation of at least one control surface 114, 116, 118 of the aircraft 100, and/or the like.

A pilot (not shown) or other operator of the aircraft 100 may be in the cockpit 104 of the aircraft 100 to control the operation (e.g., speed, direction, altitude, etc.) of the aircraft 100. The pilot may interact with a variety of control devices (not shown) within the cockpit 104 to control the actions of the aircraft 100. The control devices may be configured to detect a pilot action and transmit pilot input data representing a desired action of the aircraft 100 (e.g., an electrical signal encoding the detected desired action) to the flight controller 120. A pilot control device may include a throttle lever, an inceptor stick, a lift lever, a steering wheel, a brake pedal, a pedal control, a toggle, a joystick, a collective pitch control device, an alpha-numeric input device (e.g., a keyboard), a pointing device, an audio input device (e.g., a microphone, a voice response system, etc.), a cursor control device (e.g., a mouse), a touchpad, an optical scanner, a video capture device, a touchscreen, and/or the like.

The flight controller 120 may identify inputs from the pilot and/or remote operator via one or more control devices and use those inputs to control various components of the aircraft 100. The aircraft 100 may perform the actions desired by the pilot and/or remote operator by way of commands generated by the flight controller 120 to move control surfaces 114, 116, 118 and/or control the motor assemblies 106. In some cases, the flight controller 120 may also receive signals from sensor(s) 122. The sensors 122 may provide a variety of information to the controller 120, such as location (e.g., latitude, longitude, altitude, etc.), obstructions, temperature, humidity, other environmental factors, etc. The flight controller 120 may be configured to change the operation of the aircraft 100 responsive to signals from the sensors 122.

The flight controller 120 may include a microprocessor, a digital signal processor (DSP), a system on a chip (SoC), a field-programmable gate array (FPGA), a complex programmable logic device (CPLD), an application specific integrated circuit (ASIC), a multi-chip module, a printed circuit board, and/or the like. In some embodiments, the flight controller 120 is configured to receive one or more pilot input signals from one or more pilot control devices, perform one or more signal processing operations (e.g., one or more time-frequency analysis operations) on the pilot control signal(s) to generate one or more transformed signals, and determine the pilot command signal based on the transformed signal(s). In some examples, the flight controller 120 may use one or more trained machine learning models to perform the signal processing operation(s) on pilot control signal(s) and/or sensor signal(s) to generate commands for various components of aircraft 100.

As described above, in some cases, the flight controller unit 120 may determine one or more command signals for controlling the aircraft 100 and/or a trajectory generated for the aircraft 100 based on sensor data provided by the sensor(s) 122. The sensor(s) 122 may include vision sensor(s), depth sensor(s) (e.g., LiDAR sensor(s)), torque sensor(s), gyroscope(s), accelerometer(s), magnetometer(s), inertial measurement unit(s) (IMU(s)), pressure sensor(s), force sensor(s), proximity sensor(s), displacement sensor(s), vibration sensor(s), environmental sensor(s), and/or the like.

In some cases, the sensors 122 may include AoA sensors configured to determine a vane angle (e.g., a local airstream angle with respect to the fuselage horizontal reference plane). In some cases, two AoA sensors and/or vanes may located on a nose of the aircraft 100 and configured to interface with the aircraft 100. Each AoA sensor may include an aerodynamically swept vane, with integral, long-life ceramic heaters, that senses the airflow. The vane may be free to move through a full 360 degrees and may be accurately counterbalanced so that the position of the vane is determined entirely by the airstream direction around it.

It should be understood that in the context of the electric aircraft 100, an interruption of the operation of one or more of the sensors 122 may result in unsafe, or at least non-ideal, operating conditions. For example, an inaccurate reading of an AoA from an AoA sensor may cause other functions to activate (e.g., a stall barrier function) that may result in a loss of lift and/or a loss of thrust of the aircraft 100, resulting in possibly unsafe flying conditions. Thus, it is desirable to ensure the integrity of the readings measured and received from the AoA sensors.

According to examples of the disclosure, an AoA controller may be in communication with the AoA sensors and receive vane angle data from the vanes of each of the two AoA sensors. For instance, the AoA controller may receive first vane angle data from a first vane and receive second vane angle data from a second vane. Before comparing the two vane angle data values to determine a delta (e.g., a discrepancy value between the two vane angle data values), the AoA controller may generate an estimated AoA for each received vane angle value in order to determine a more accurate AoA for the aircraft 100 based on the motion of the aircraft 100 at the time of the vane angle readings. For instance, the aircraft 100 may experience side slip (e.g., due to crosswind) at the time of the readings which may cause the vane angle data to be inaccurate with respect to a true AoA of the aircraft 100.

In some examples, the AoA controller may generate a side slip estimate based on inertial data and/or air speed data and may apply the side slip estimate to the vane angle data to generate estimated AoAs. For instance, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically.

In some cases, once the estimated AoAs are generated, the AoA controller may determine a delta between the estimated AoAs to determine if one or both of the AoA sensors are malfunctioning. For instance, the AoA controller may determine a first estimated AoA associated with the first vane based at least in part on the side slip estimate and determine a second estimated AoA associated with the second vane based at least in part on the side slip estimate. The AoA controller may still further determine a difference between the first estimated AoA and the second estimated AoA and perform an action in response to the delta being above a threshold value. Reasons for discrepancies between vane angle values measured by different AoA sensors and an aircraft's true AoA may include fuselage effects, such as flow interference around the nose at different combinations of true AoA and angle-of-sideslip (AoS) causing different local AoA at the different vanes. Other factors that may cause these discrepancies include kinematic effects, such as roll, pitch, and yaw body rates (p,q,r), causing local linear velocities at the vanes, relative to a center of gravity of the aircraft, because they are not mounted at the center of gravity of the aircraft. The local velocities at the vanes may affect the relative wind at the vane locations, and therefore the local AoA as measured by the vanes.

In some cases, the AoA controller may determine that the difference is above a threshold, indicating that one or more of the AoA sensors is malfunctioning. In this case, the AoA controller may determine that the AoA data (e.g., vane angle data) cannot be relied upon and thus deactivate functions that operate using the AoA data. For instance, the AoA controller may deactivate a stall barrier protection in response to determining that the AoA data is inaccurate (e.g., that the difference is above a threshold, indicating that one or more of the AoA sensors is malfunctioning).

Although discussed in the context of the eVTOL aircraft 100, it should be understood that the apparatus, systems, and methods disclosed herein to determine the integrity of AoA sensors and AoA data may be applied to any suitable application. For example, the mechanism discussed herein may be applied to a conventional takeoff and landing (CTOL) aircraft or other transportation vehicles. The CTOL may include one or more propulsion motors located in the front, rear, or along the wings of the aircraft that may need to be rebooted during flight using the mechanisms disclosed herein.

FIG. 1B a block diagram of the aircraft 100, according to examples of the disclosure, from a front perspective showing a nose 124, a vane 126, and a vane 128.

In some cases, the sensors 122 may include the vane 126 and the vane 128 coupled to respective AoA sensors configured to determine a vane angle (e.g., a local airstream angle with respect to the fuselage horizontal reference plane). As illustrated in FIG. 1B, the vane 126 and the vane 128 are located on the nose 124 of the aircraft 100 and configured to interface with the aircraft 100 while vane 126 experiences an airstream angle 130 and vane 128 experiences an airstream angle 132. That is, although both the vane 128 and vane 126 are located on the nose 124, airstream angle 130 and airstream 132 may be difference due to the plane maneuvering in the air (e.g., experiencing side slip). The vane 126 and the vane 128 may include aerodynamically swept vanes, with integral, long-life ceramic heaters, that sense airflow. The vane 126 and the vane 128 may be free to move through a full 360 degrees and may be accurately counterbalanced so that the position of the vane 126 and the vane 128 is determined entirely by the airstream direction around it.

Given the vane 126 and the vane 128 locations relative to a center of gravity of the aircraft 100, it is expected that discrepancies between vane angle values experienced by vane 126 and the vane 128 may occur. For instance, as the aircraft 100 experiences flow interference around the nose at different combinations of true AoA and angle-of-sideslip (AoS), vane 126 and vane 128 may experience different local AoA at each respective vane 126 and vane 128. Other factors that may cause these discrepancies include kinematic effects, such as roll, pitch, and yaw body rates (p,q,r), causing local linear velocities at the vane 126 and the vane 128, relative to a center of gravity of the aircraft, because they are not mounted at the center of gravity of the aircraft. The local velocities at the vane 126 and the vane 128 may affect the relative wind at the vane locations, and therefore the local AoA as measured by the vane 126 and the vane 128.

FIG. 2 depicts an example architecture 200 of a controller area network (CAN) bus 202 system of an aircraft, such as the aircraft 100, according to at least one example. The CAN bus 202 may include any bus system such as any serial bus system used for communications on the aircraft 100. The CAN bus 202 is a physical vehicle bus unit including a central processing unit (CPU), a CAN controller, and a transceiver designed to allow devices to communicate with each other's applications without the need of a host computer which is located physically at electric aircraft 100. CAN bus 202 may include physical circuit elements that may use, for instance and without limitation, twisted pair, digital circuit elements/FGPA, microcontroller, or the like to perform, without limitation, processing and/or signal transmission processes and/or tasks; circuit elements may be used to implement CAN bus 202 components and/or constituent parts as described in further detail below. CAN bus 202 may include multiplex electrical wiring for transmission of multiplexed signaling. CAN bus 202 may include message-based protocol(s), wherein the invoking program sends a message to a process and relies on that process and its supporting infrastructure to then select and run appropriate programing.

In some examples, the electric aircraft may include a plurality of CAN bus 202 and may be mechanically connected to the electric aircraft 100. The hardware of the CAN bus 202 is integrated within the infrastructure of the electric aircraft 100. CAN bus 202 may be communicatively connected to the electric aircraft 100 and/or with a plurality of devices outside of the electric aircraft as well. In some examples, the electric aircraft may include multiple CAN bus systems that connect to the various components of the electric aircraft 100.

The CAN bus 202 may avoid the need for large, multi-core wiring harnesses used in eVTOL aircraft. The CAN bus 202 speed my may reach 1 Mbit/sec, which may be achieved with a bus length of up to 40 meters when using a twisted wire pair for communication. The CAN bus 202 is terminated at each end, typically using a resistor of 120 Ohms. For lengths longer than 40 meters the bus speed is reduced, for instance, 1000-meter bus may be achieved with a 50 Kbit/sec bus speed.

The electric aircraft 100 may include components such as a fault detection system 204, sensor 206, propulsor 208, programmable logic device 210, display 212, power management system 214, flight controller 216, steering components 218, pilot control 220, landing gear 222, gyroscope 224, and other such components that may couple to the CAN bus 202.

The fault detection system 204 may include one or more sensors 206 and components to detect, identify, and generate alerts with respect to one or more faults of the electric aircraft 100. For example, the fault detection system may include an AoA controller 226.

The electric aircraft 100 may include a plurality of sensors 206 that connect with CAN interfaces to the CAN bus 202 to transmit measured state data. For instance, and without limitation, the CAN bus units may transmit measured state data from at least a sensor 206 communicatively connected to at least a pilot control 220. Measured state data originating from sensors 206 may include electrical, electromagnetic, visual, audio, radio waves, or another undisclosed signal type alone or in combination. At least a sensor 206 communicatively connected to at least a pilot control 220 may include one or more sensors disposed on, near, around or within at least pilot control 220.

The pilot control 220 may include a throttle lever, inceptor stick, collective pitch control, steering wheel, brake pedals, pedal controls, toggles, joystick. At least a sensor 206 may include a motion sensor to detect spinning, rotating, oscillating, gyrating, jumping, sliding, reciprocating, or the like of various flight components. The sensor 206 may include, torque sensor, gyroscope 224, accelerometer, torque sensor, magnetometer, inertial measurement unit (IMU), pressure sensor, force sensor, proximity sensor, displacement sensor, vibration sensor, Hall sensor, vane sensor, AoA sensor, among others.

In some examples, sensor 206 may include a sensor suite which may include a plurality of sensors 206 that may detect similar or unique phenomena. For example, in a non-limiting embodiments, sensor suite may include a plurality of accelerometers, a combination of accelerometers and gyroscopes, or a combination of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

The propulsor 208 may include components such as the motor assembly 106 as described above with respect to FIG. 1A. The motor may include without limitation, any electric motor, where an electric motor is a device that converts electrical energy into mechanical energy, for instance by causing a shaft to rotate. The motor may be driven by direct current (DC) electric power; for instance, at least a first motor may include a brushed DC at least a first motor, or the like. The motor may also be driven by electric power having varied, or reversing, voltage levels such as alternating current (AC) power as produced by an alternating current generator and/or inverter, or otherwise varying power, such as produced by a switching power source. The propulsor 208 is connected to the CAN bus 202 that enables communication between various components of the electric aircraft 100. In some examples, the CAN bus 202 enables cross-communication between multiple propulsors that enables a first propulsor to cause a second propulsor (and/or inverter) to change operations and/or communicate to the programmable logic device 210 to cause one or more propulsors 208 to change states.

The programmable logic device 210 forms a digital circuit to change state of the propulsor 208, such as to power on/off through the use of the programmable logic device 210. The programmable logic device 210 uses programmable logic to demodulate CAN messages on the CAN bus 202, the message including an identifier and a payload, and relay the payload to one or more components such as the inverter of propulsor 208. In this manner, the programmable logic device 210 is able to filter the CAN messages to identify the signals to power on or power off the inverter of propulsor 208 and can therefore act as a state machine to control the state of the propulsor 208 separate from the control signals and in response to a sequence on the serial bus, thereby forming a sequence detection state machine.

The programmable logic device 210 may be used to filter CAN bus messages based on the pre-programmed stored identifier, in this manner, the programmable logic device 210 may be used to relay the payload to either a subsequent comparator for decoding a keyed function as part of a handshake function or for consumption by the propulsor 208 for powering on/off. In some examples the multiple comparisons may be compared using Boolean comparison and in the event that both conditions are met, it would represent a successful de-keying and therefore result in a change in state of an inverter.

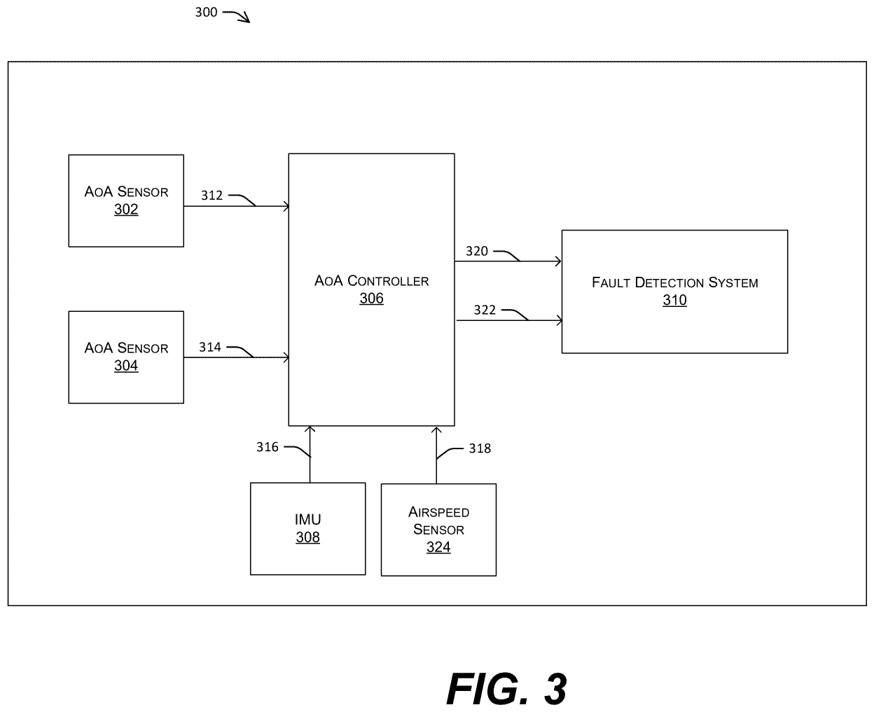

FIG. 3 is a flow diagram depicting an example architecture 300 illustrating a flow of data for generating estimated AoAs for an aircraft. The architecture may include an AoA sensor 302, an AoA sensor 304, an AoA controller 306, an IMU 308, and/or a fault detection system 310.

According to examples of the disclosure, the AoA controller 306 may be in communication with the AoA sensor 302 and the AoA sensor 304 and receive vane angle data 312 and vane angle data 314 from the vanes of each of the AoA sensor 302 and the AoA sensor 304. For instance, the AoA controller 306 may receive the first vane angle data 312 from a first vane and receive the second vane angle data 314 from a second vane. Before comparing the two vane angle data values to determine a delta (e.g., a discrepancy value between the two vane angle data values), the AoA controller 306 may generate an estimated AoA for each received vane angle value in order to determine a more accurate AoA for the aircraft 100 based on the motion of the aircraft 100 at the time of the vane angle readings. For instance, the aircraft 100 may experience side slip (e.g., due to crosswind) at the time of the readings which may cause the vane angle data to be inaccurate with respect to a true AoA of the aircraft 100.

In some examples, the AoA controller 306 may generate a side slip estimate based on inertial data and/or air speed data and may apply the side slip estimate to the vane angle data 312 and vane angle 314 to generate estimated AoAs. For instance, measurement of side slip may be obtained via an inertial measurement unit (IMU) 308 providing IMU data 316 as well as airspeed data 318. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically. In some cases, the estimated AoA may be referred to as a local velocity at the AoA vane expressed as a wind frame. In some cases, the wind frame may be expressed in the following equation:

$${\vec{V}}_{w} = [ \begin{matrix}cos α cos β & sin β & sin α cos β \\ - cos α sin β & cos β & - sin α sin β \\ - sin α & 0 & cos α\end{matrix} ] ( \vec{ω} \times \vec{r} ) + [ \begin{matrix}{V}_{T} \\ 0 \\ 0\end{matrix} ] . \qquad Equation 1$$

In some examples,

$$[ \begin{matrix}cos α cos β & sin β & sin α cos β \\ - cos α sin β & cos β & - sin α sin β \\ - sin α & 0 & cos α\end{matrix} ]$$

may represent a transformation from body to wind frame.

In some examples, \vec{ω} represents an angular velocity of a body of the aircraft 100. In some cases, the angular velocity is relative to a wind frame and is expressed in a body frame.

In some examples, \vec{r} represents a vector from a center of gravity of a body of the aircraft 100 to an aerodynamic center of AoA vane expressed in a body frame.

In some examples,

$$[ \begin{matrix}{V}_{T} \\ 0 \\ 0\end{matrix} ]$$

represents a velocity of a body of the aircraft 100 relative to a wind frame and expressed as the wind frame.

In some cases, once the estimated AoAs are generated, the AoA controller 306 may determine a delta between the estimated AoAs to determine if one or both of the AoA sensors are malfunctioning. For instance, the AoA controller 306 may determine a first estimated AoA 320 associated with the first vane based at least in part on the side slip estimate and determine a second estimated AoA 322 associated with the second vane based at least in part on the side slip estimate. In some cases, the AoA controller may provide the first estimated AoA 320 and the second estimated AoA 322 to the fault detection system 310. The AoA controller 306 and/or the fault detection system 310 may still further determine a difference between the first estimated AoA 320 and the second estimated AoA 322 and perform an action in response to the delta being above a threshold value. Reasons for discrepancies between vane angle values measured by different AoA sensors and an aircraft's true AoA may include fuselage effects, such as flow interference around the nose at different combinations of true AoA and angle-of-sideslip (AoS) causing different local AoA at the different vanes. Other factors that may cause these discrepancies include kinematic effects, such as roll, pitch, and yaw body rates (p,q,r), causing local linear velocities at the vanes, relative to a center of gravity of the aircraft, because they are not mounted at the center of gravity of the aircraft. The local velocities at the vanes may affect the relative wind at the vane locations, and therefore the local AoA as measured by the vanes.

In some cases, the AoA controller 306 and/or the fault detection system 310 may determine that the difference is above a threshold, indicating that one or more of the AoA sensor 302 and/or the AoA sensor 304 is malfunctioning. In this case, the AoA controller 306 and/or the fault detection system 310 may determine that the AoA data (e.g., vane angle data) cannot be relied upon and thus deactivate functions that operate using the AoA data. For instance, the AoA controller 306 and/or the fault detection system 310 may deactivate a stall barrier protection in response to determining that the AoA data is inaccurate (e.g., that the difference is above a threshold, indicating that one or more of the AoA sensors is malfunctioning).

In some cases, the AoA controller 306 may determine that the difference is not at or above a threshold value and determine that both the AoA sensor 302 and the AoA sensor 304 are providing AoA data that is in agreement. In this case, the AoA controller 306 may continue to receive data (e.g., vane angle data) from the AoA sensors.

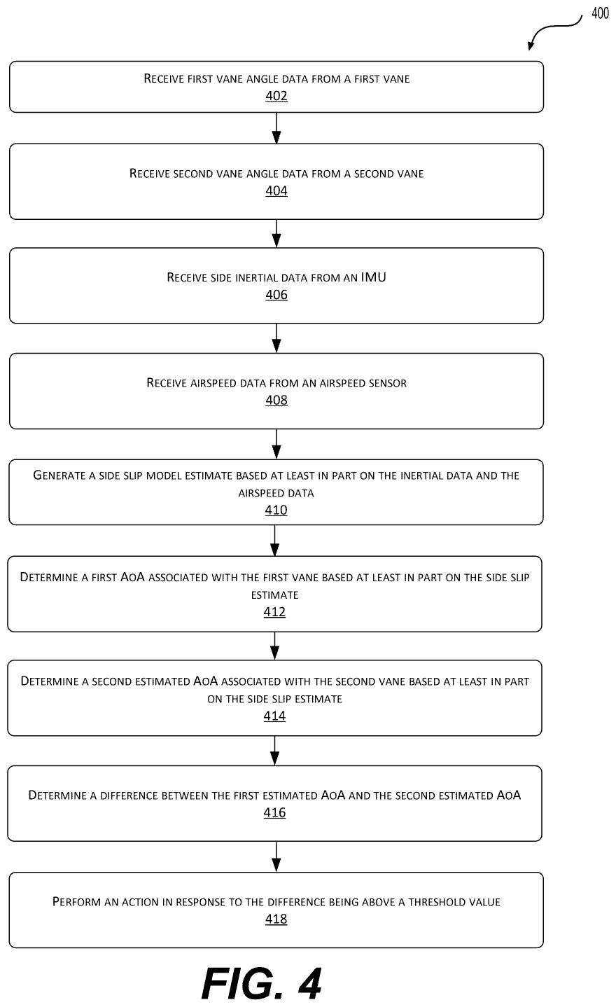

FIG. 4 is a flow diagram depicting an example method 400 for ensuring the integrity of AoA data monitored by aircraft 100 of FIG. 1A, according to examples of the disclosure. The processes of method 400 may be performed by the controller 226, individually or in conjunction with one or more other elements of the CAN bus 202, such as the sensors 206 and/or the fault detection system 204. Method 400 allows the controller 226 to generate estimated AoA vane angles and determine if an AoA sensor is malfunctioning. According to examples of the disclosure, method 400 may be performed while the aircraft 100 is in flight.

At block 402, the method 400 may include receiving first vane angle data from a first vane and at block 404, the method 400 may include receive second vane angle data from a second vane. For example, an AoA controller may be in communication with the AoA sensors and receive vane angle data from the vanes of each of the two AoA sensors. For instance, the AoA controller may receive first vane angle data from a first vane and receive second vane angle data from a second vane.

At block 406, the method 400 may include receiving inertial data from an IMU and at block 408, the method 400 may include receiving airspeed data from an airspeed sensor. For instance, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically.

At block 410, the method 400 may include generate a side slip estimate based at least in part on the inertial data and the airspeed data. For example, the AoA controller may generate a side slip estimate based on inertial data and/or air speed data and may apply the side slip estimate to the vane angle data to generate estimated AoAs.

At block 412, the method 400 may include determining a first estimated angle-of-attack (AoA) associated with the first vane based at least in part on the side slip estimate and at block 414, the method 400 may include determining a second estimated AoA associated with the second vane based at least in part on the side slip estimate. For example, in some cases the estimated AoA may be referred to as a local velocity at the AoA vane expressed as a wind frame. In some cases, the wind frame may be expressed by Equation 1.

At block 416, the method 400 may include determining determine a difference between the first estimated AoA and the second estimated AoA and at block 418, the method 400 may include performing performing an action in response to the difference being above a threshold value. For example, once the estimated AoAs are generated, the AoA controller 306 may determine a delta between the estimated AoAs to determine if one or both of the AoA sensors are malfunctioning. For instance, the AoA controller 306 may determine a first estimated AoA 320 associated with the first vane based at least in part on the side slip estimate and determine a second estimated AoA 322 associated with the second vane based at least in part on the side slip estimate. In some cases, the AoA controller may provide the first estimated AoA 320 and the second estimated AoA 322 to the fault detection system 310. The AoA controller 306 and/or the fault detection system 310 may still further determine a difference between the first estimated AoA 320 and the second estimated AoA 322 and perform an action in response to the delta being above a threshold value.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

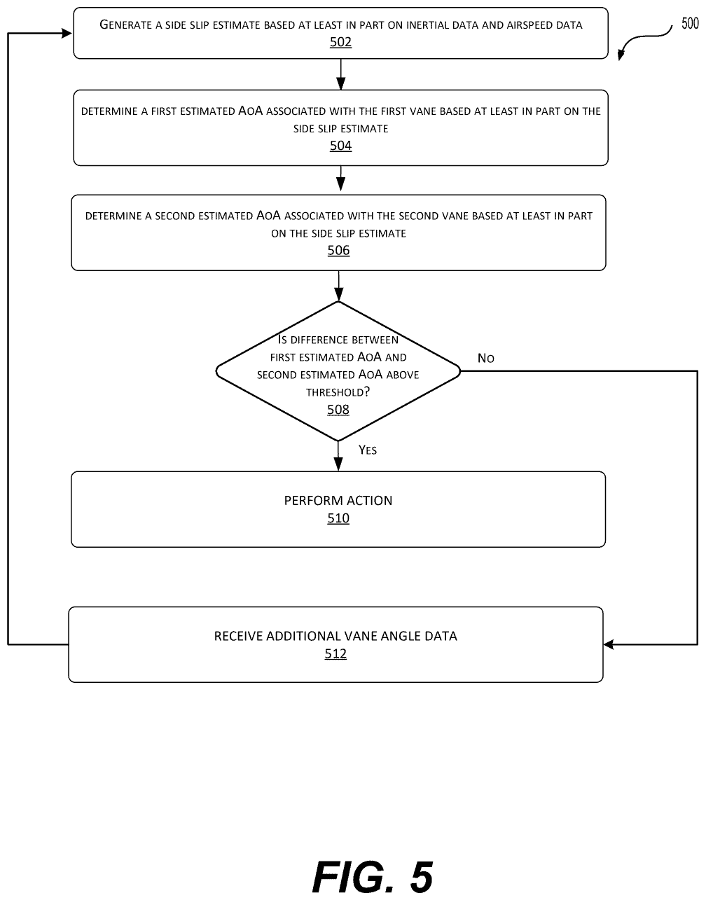

FIG. 5 is a flow diagram depicting an example method 500 for ensuring the integrity of AoA data monitored by aircraft 100 of FIG. 1A, according to examples of the disclosure. The processes of method 500 may be performed by the controller 226, individually or in conjunction with one or more other elements of the CAN bus 202, such as the sensors 206 and/or the fault detection system 204. Method 500 allows the controller 226 to generate estimated AoA vane angles and determine if an AoA sensor is malfunctioning. According to examples of the disclosure, method 500 may be performed while the aircraft 100 is in flight.

At block 502, the method 500 may include generating a side slip estimate based at least in part on inertial data and airspeed data. For instance, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically.

At block 504, the method 500 may determining a first estimated angle-of-attack (AoA) associated with the first vane based at least in part on the side slip estimate and at block 506, the method 500 may include determining a second estimated AoA associated with the second vane based at least in part on the side slip estimate. In some cases, the wind frame may be expressed by Equation 1. For instance, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically.

At block 508, the method 500 may include determining a difference between the first estimated AoA and the second estimated AoA and if the difference is above a threshold value. For example, For example, once the estimated AoAs are generated, the AoA controller 306 may determine a delta between the estimated AoAs to determine if one or both of the AoA sensors are malfunctioning. For instance, the AoA controller 306 may determine a first estimated AoA 320 associated with the first vane based at least in part on the side slip estimate and determine a second estimated AoA 322 associated with the second vane based at least in part on the side slip estimate. In some cases, the AoA controller may provide the first estimated AoA 320 and the second estimated vane angle 322 to the fault detection system 310. The AoA controller 306 and/or the fault detection system 310 may still further determine a difference between the first estimated AoA 320 and the second estimated AoA 322 and perform an action in response to the delta being above a threshold value.

At block 510, if it is determined the difference is above a threshold value, the method 500 may include performing an action. For instance, in this case, the AoA controller 306 and/or the fault detection system 310 may determine that the AoA data (e.g., vane angle data) cannot be relied upon and thus deactivate functions that operate using the AoA data. For instance, the AoA controller 306 and/or the fault detection system 310 may deactivate a stall barrier protection in response to determining that the AoA data is inaccurate (e.g., that the difference is above a threshold, indicating that one or more of the AoA sensors is malfunctioning).

At block 512, if it is determined the difference is not above a threshold value, the method 500 may include receiving additional vane angle data. For instance, the AoA controller 306 may determine that the difference is not at or above a threshold value and determine that both the AoA sensor 302 and the AoA sensor 304 are providing AoA data that is in agreement. In this case, the AoA controller 306 may continue to receive data (e.g., vane angle data) from the AoA sensors.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

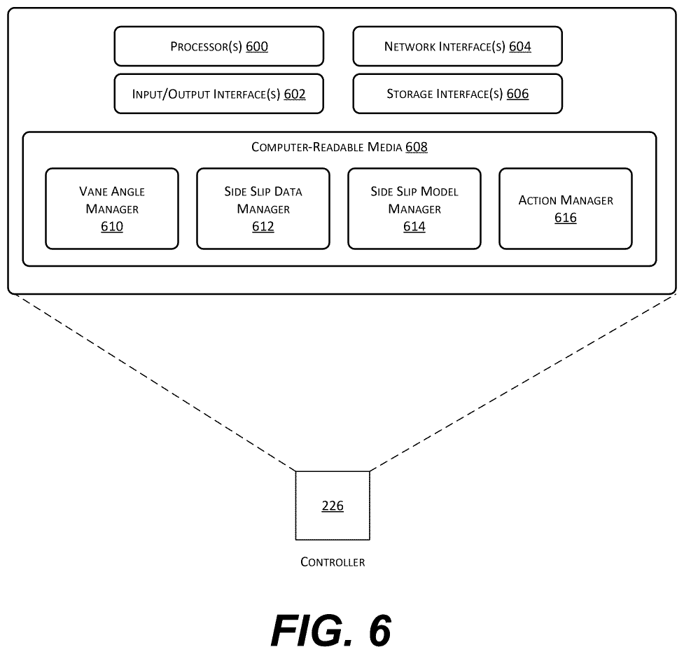

FIG. 6 is a block diagram of the controller 226 of the CAN Bus 202 of FIG. 2, according to examples of the disclosure. The controller 226 includes one or more processor(s) 600, one or more input/output (I/O) interface(s) 602, one or more communication interface(s) 604, one or more storage interface(s) 606, and computer-readable media 608. In examples, the processor(s) 600, I/O interfaces 602, communications interface(s) 604, storage interface(s) 606, and/or computer-readable media 608 may be part of an electronic device or computer system.

In some implementations, the processors(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 600 may possess its own local memory, which also may store program modules, program data, and/or one or more operating systems. The one or more processor(s) 600 may include one or more cores.

The one or more input/output (I/O) interface(s) 602 may enable the controller 226 to detect interaction with a human operator. For example, the operator may provide task instructions (e.g., intended flight maneuvers) or monitor metrics (e.g., motor speed, motor torque, etc.).

The network interface(s) 604 may enable the controller 226 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of WiFi, cellular radio, a wireless (e.g., IEEE 802.1x-based) interface, a Bluetooth® interface, and the like. Thus, the network interface(s) 604 may enable one or both of the control planes 118, 120.

The storage interface(s) 606 may enable the processor(s) 600 to interface and exchange data with the computer-readable media 608, as well as any storage device(s) external to the controller 226. The storage interface(s) 606 may further enable access to removable media.

The computer-readable media 608 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 608 may be implemented as computer-readable storage media (CRSM), which may be any available physical media accessible by the processor(s) 600 to execute instructions stored on the computer readable media 608. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 600. The computer-readable media 608 may have an operating system (OS) and/or a variety of suitable applications stored thereon. The OS, when executed by the processor(s) 600 may enable management of hardware and/or software resources of the controller 226.

Several components such as instruction, data stores, and so forth may be stored within the computer-readable media 608 and configured to execute on the processor(s) 600. The computer readable media 608 may have stored thereon a vane angle data manager 610, an inertial data manager 612, a side slip estimate manager 614, and an action manager 616. It will be appreciated that each of the components 610, 612, 614, and 616, may have instructions stored thereon that when executed by the processor(s) 600 may enable various functions pertaining to operating the controller 226, as described herein.

The instructions stored in the vane angle data manager 610, when executed by the processor(s) 600, may configure the controller 226 to receive and store vane angle data. For example, an vane angle data manager 610 may be in communication with the AoA sensors and receive vane angle data from the vanes of each of the two AoA sensors. For instance, the vane angle data manager 610 may receive first vane angle data from a first vane and receive second vane angle data from a second vane.

The instructions stored in the inertial data manager 612, when executed by the processor(s) 600, may configure the controller 226 to receive and store inertial data. For instance, measurement of side slip may be obtained via an inertial measurement unit (IMU) providing IMU data as well as airspeed data. In some examples, other data sources may provide data used to measure side slip, such as pneumatic sensor (e.g., a cone with static pressure), a smart pitot probe (e.g., static ports on probe), other static sources to measure side slip, or a side slip sensor (e.g., a third vane sensor positioned vertically.

The instructions stored in the side slip estimate manager 614, when executed by the processor(s) 600, may configure the controller 226 to generate and store a side slip estimate. For instance, For example, the side slip estimate manager 614 may generate a side slip estimate based on inertial data and/or air speed data and may apply the side slip estimate to the vane angle data to generate estimated AoAs. In some cases, the estimated AoA may be referred to as a local velocity at the AoA vane expressed as a wind frame. In some cases, the wind frame may be expressed by Equation 1.

The instructions stored in the, when executed by the processor(s) 600, may configure the controller 226 to determine a difference between vane angles and determine an action to be taken based on the difference. For example, once the estimated AoAs are generated, the action manager 616 may determine a delta between the estimated AoAs to determine if one or both of the AoA sensors are malfunctioning. For instance, the action manager 616 may determine a first estimated AoA associated with the first vane based at least in part on the side slip estimate and determine a second estimated AoA associated with the second vane based at least in part on the side slip estimate. In some cases, the action manager 616 may provide the first estimated AoA and the second estimated AoA to a fault detection system. The action manager 616 and/or the fault detection system 310 may still further determine a difference between the first estimated AoA and the second estimated AoA and perform an action in response to the delta being above a threshold value. In some cases, if it is determined the difference is above a threshold value, the action manager 616 may determine that the AoA data (e.g., vane angle data) cannot be relied upon and thus deactivate functions that operate using the AoA data. For instance, the action manager 616 may deactivate a stall barrier protection in response to determining that the AoA data is inaccurate (e.g., that the difference is above a threshold, indicating that one or more of the AoA sensors is malfunctioning). In some cases, if it is determined the difference is not above a threshold value, the action manager 616 may determine that the difference is not at or above a threshold value and determine that both the AoA sensor 302 and the AoA sensor 304 are providing AoA data that is in agreement. In this case, the action manager 616 may determine to continue to receive data (e.g., vane angle data) from the AoA sensors.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

### Example Clauses

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

Clause A: In an aspect of the present disclosure, a method comprising: receive first vane angle data from a first vane, receive second vane angle data from a second vane, receive inertial data from an IMU, receive airspeed data from an airspeed sensor, generate a side slip estimate based at least in part on the inertial data and the airspeed data, determine a first estimated angle-of-attack (AoA) associated with the first vane based at least in part on the side slip estimate, determine a second estimated AoA associated with the second vane based at least in part on the side slip estimate, determine a difference between the first estimated AoA and the second estimated AoA, and perform an action in response to the difference being above a threshold value.

Clause B: the method of clause A, wherein the action comprises deactivating a stall barrier protection.

Clause C: the method of clause A, wherein the first vane and the second vane are located on a nose of an aerial vehicle such that the first vane experiences different sideslip effects than the second vane.

Clause D: the method of clause A, wherein generating the side slip estimate includes determining an angle-of-attack (AoA) vane velocity relative to a wind frame.

Clause E: the method of clause A, wherein generating the side slip estimate includes determining an angular velocity of a body of an aerial vehicle in which the first vane and the second vane are attached, the angular velocity being relative to a wind frame and being expressed in a body frame.

Clause F: the method of clause A, wherein generating the side slip estimate includes determining a velocity of a body of an aerial vehicle in which the first vane and the second vane are attached relative to a wind frame and expressed as the wind frame.

Clause G: the method of clause A, wherein generating the side slip estimate includes determining a vector from a center of gravity of a body of an aerial vehicle in which the first vane and the second vane are attached to an aerodynamic center of AoA vane expressed in a body frame.

Clause H: In another aspect of the present disclosure, an aerial vehicle comprising: a processor, and memory storing computer readable instructions causing the processors to perform one or more operations including: receive first vane angle data from a first vane, receive second vane angle data from a second vane, receive inertial data from an IMU, receive airspeed data from an airspeed sensor, generate a side slip estimate based at least in part on the inertial data and the airspeed data, determine a first estimated angle-of-attack (AoA) associated with the first vane based at least in part on the side slip estimate, determine a second estimated AoA associated with the second vane based at least in part on the side slip estimate, determine a difference between the first estimated AoA and the second estimated AoA, and perform an action in response to the difference being above a threshold value.

Clause I: the aerial vehicle of clause H, further comprising four horizontal propellers and one vertical propeller.

Clause J: the aerial vehicle of clause H, wherein the first vane and the second vane are located on a nose of the aerial vehicle such that the first vane experiences different sideslip effects than the second vane.

Clause K: the aerial vehicle of clause H, wherein the first vane and the second vane mounted at a location other than the center of gravity of the aerial vehicle.

Clause L: the aerial vehicle of clause H, wherein the first vane experiences a first AoA and the second vane experiences a second AoA that is different than the first AoA.

Clause M: aerial vehicle of clause H, further comprising: one or more propellors, and a high-voltage battery back configured to power the one or more propellors.

Clause N: the aerial vehicle of clause H, wherein generating the side slip estimate includes determining an angle-of-attack (AoA) vane velocity relative to a wind frame.

Clause O: in yet another aspect of the present disclosure, method comprising: generate a side slip estimate based at least in part on inertial data and airspeed data, determine a first estimated angle-of-attack (AoA) associated with the first vane based at least in part on the side slip estimate, determine a second estimated AoA associated with the second vane based at least in part on the side slip estimate, and determine a difference between the first estimated AoA and the second estimated AoA.

Clause P: the method of clause O, further comprising: deactivating a stall barrier protection in response to the difference being above a threshold value, or maintaining a stall barrier protection in response to the difference being above below a threshold value.

Clause Q: the method of clause O, further comprising: receive first vane angle data from a first vane, receive second vane angle data from a second vane, receive the inertial data from an IMU, receive the airspeed data from an airspeed sensor, and generating the side slip estimate based at least in part on the inertial data and the airspeed data.

Clause R: the method of clause O or R, wherein generating the side slip estimate includes determining an angle-of-attack (AoA) vane velocity relative to a wind frame.

Clause S: the method of clause O or R, wherein generating the side slip estimate includes determining an angular velocity of a body of an aerial vehicle in which the first vane and the second vane are attached, the angular velocity being relative to a wind frame and being expressed in a body frame.

Clause T: the method of clause O or R, wherein generating the side slip estimate includes determining a velocity of a body of an aerial vehicle in which the first vane and the second vane are attached relative to a wind frame and expressed as the wind frame.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A method comprising:
receive first vane angle data from a first vane;
receive second vane angle data from a second vane;
receive inertial data from an IMU;
receive airspeed data from an airspeed sensor;
generate a side slip estimate based at least in part on the inertial data and the airspeed data;
determine a first estimated angle-of-attack (AoA) associated with the first vane based at least in part on the side slip estimate;
determine a second estimated AoA associated with the second vane based at least in part on the side slip estimate;
determine a difference between the first estimated AoA and the second estimated AoA; and
perform an action in response to the difference being above a threshold value.

2. The method of claim 1, wherein the action comprises deactivating a stall barrier protection.

3. The method of claim 1, wherein the first vane and the second vane are located on a nose of an aerial vehicle such that the first vane experiences different sideslip effects than the second vane.

4. The method of claim 1, wherein generating the side slip estimate includes determining an angle-of-attack (AoA) vane velocity relative to a wind frame.

5. The method of claim 1, wherein generating the side slip estimate includes determining an angular velocity of a body of an aerial vehicle in which the first vane and the second vane are attached, the angular velocity being relative to a wind frame and being expressed in a body frame.

6. The method of claim 1, wherein generating the side slip estimate includes determining a velocity of a body of an aerial vehicle in which the first vane and the second vane are attached relative to a wind frame and expressed as the wind frame.

7. The method of claim 1, wherein generating the side slip estimate includes determining a vector from a center of gravity of a body of an aerial vehicle in which the first vane and the second vane are attached to an aerodynamic center of AoA vane expressed in a body frame.

8. An aerial vehicle comprising:
a processor; and
memory storing computer readable instructions causing the processors to perform one or more operations including:
receive first vane angle data from a first vane;
receive second vane angle data from a second vane;
receive inertial data from an IMU;
receive airspeed data from an airspeed sensor;
generate a side slip estimate based at least in part on the inertial data and the airspeed data;
determine a first estimated angle-of-attack (AoA) associated with the first vane based at least in part on the side slip estimate;
determine a second estimated AoA associated with the second vane based at least in part on the side slip estimate;
determine a difference between the first estimated AoA and the second estimated AoA; and
perform an action in response to the difference being above a threshold value.

9. The aerial vehicle of claim 8, further comprising four horizontal propellers and one vertical propeller.

10. The aerial vehicle of claim 8, wherein the first vane and the second vane are located on a nose of the aerial vehicle such that the first vane experiences different sideslip effects than the second vane.

11. The aerial vehicle of claim 8, wherein the first vane and the second vane mounted at a location other than the center of gravity of the aerial vehicle.

12. The aerial vehicle of claim 8, wherein the first vane experiences a first AoA and the second vane experiences a second AoA that is different than the first AoA.

13. The aerial vehicle of claim 8, further comprising:
one or more propellors; and
a high-voltage battery back configured to power the one or more propellors.

14. The aerial vehicle of claim 8, wherein generating the side slip estimate includes determining an angle-of-attack (AoA) vane velocity relative to a wind frame.

15. A method comprising:
generate a side slip estimate based at least in part on inertial data and airspeed data;
determine a first estimated angle-of-attack (AoA) associated with the first vane based at least in part on the side slip estimate;
determine a second estimated AoA associated with the second vane based at least in part on the side slip estimate; and
determine a difference between the first estimated AoA and the second estimated AoA.

16. The method of claim 15, further comprising:
deactivating a stall barrier protection in response to the difference being above a threshold value; or
maintaining a stall barrier protection in response to the difference being above below a threshold value.

17. The method of claim 15, further comprising:
receive first vane angle data from a first vane;
receive second vane angle data from a second vane;
receive the inertial data from an IMU;
receive the airspeed data from an airspeed sensor; and
generating the side slip estimate based at least in part on the inertial data and the airspeed data.

18. The method of claim 17, wherein generating the side slip estimate includes determining an angle-of-attack (AoA) vane velocity relative to a wind frame.

19. The method of claim 17, wherein generating the side slip estimate includes determining an angular velocity of a body of an aerial vehicle in which the first vane and the second vane are attached, the angular velocity being relative to a wind frame and being expressed in a body frame.

20. The method of claim 17, wherein generating the side slip estimate includes determining a velocity of a body of an aerial vehicle in which the first vane and the second vane are attached relative to a wind frame and expressed as the wind frame.
